(19) United States
(12) Patent Application Publication
(10) Pub. No.: US 2023/0364845 A1
(43) Pub. Date: Nov. 16, 2023

(54) CLAD SIZER FOR AN EXTRUSION MACHINE

(71) Applicant: Engineered Profiles LLC, Columbus, OH (US)

(72) Inventors: Vick Dhanapal, Delaware, OH (US); Gary Oney, Londonderry, OH (US); Roger May, Lancaster, OH (US); Troy Kimmes, Johnstown, OH (US)

(21) Appl. No.: 17/745,442

(22) Filed: May 16, 2022

(51) Int. Cl. B29C 48/88; B29C 48/14; B29C 48/25; B29C 48/30

(52) U.S. Cl. CPC B29C 48/911; B29C 48/147; B29C 48/254; B29C 48/3003

(57) ABSTRACT

A sizer for cooling an extrudate, which includes a clad core and a housing. The clad core includes an extrusion channel which accommodates the extrudate, and a core vacuum port in fluid communication with the extrusion channel. The housing includes a cooling channel and a housing vacuum channel. The cooling channel does not exist in the clad core and is adapted to circulate a coolant through the housing.

### TECHNICAL FIELD

Exemplary embodiments relate generally to sizers for creating extrusion profiles.

### BACKGROUND AND SUMMARY OF THE INVENTION

Making a profile through extrusion requires two key components: a die to shape the molten material into the desired shape, and sizers to maintain the shape as the material cools to create a stable end product. Depending on the shape of the desired extrudate and the level of temperature reduction required, multiple sizers may be provided in succession to achieve adequate cooling. Typically, these sizers are made of two separately formed pieces that are joined together and define a hollow extrusion channel for the extrudate to flow through, although a single piece may be used as well.

Within the sizer components, vacuum channels may be provided above and below the extrudate to maintain the extrudate's shape as it passes through the extrusion channel. Without the vacuum channels, gravity might cause undesired deformations. However, these vacuum channels create obstacles for cooling channels, which may be required to adequately cool the extrudate. As water flows through the cooling channels, heat may be conductively removed from the extrudate. Since both the vacuum and cooling channels require interaction with the extrusion channel, positioning both types of channels in a way that provides sufficient proximity and interaction with the extrudate to achieve both adequate cooling and adequate distribution of material is spatially challenging.

That challenge is further complicated in a multi-piece sizer having a housing that houses a core. In such a multi-piece sizer, a core requires sufficient area for cooling and vacuum channels. These cooling and vacuum channels further need to be in fluid communication with cooling and vacuum sources, which may be accessed through the housing. Such considerations typically dictate a core having a significant mass to accommodate the cooling and vacuum channels. The material cost of the core may therefore be significant. On top of the material cost, the design and manufacture of the core and the housing is complex and must be precise to ensure proper operation, which may lead to significant costs.

There exists a need in the art for an improved sizer design that minimizes the material cost and size of a core. Another need exists for an improved sizer design and method of manufacture that simplifies the relationship between a housing and a core. A need also exists for an improved sizer design that is more efficient to design and manufacture. One further need is a sizer that provides improved cooling efficiency, which may result in faster extrudate output that is also of better quality.

An exemplary embodiment of the present invention may satisfy one or more of the aforementioned needs. In exemplary embodiments, a sizer for cooling an extrudate may be comprised of a housing and a clad core. The clad core may comprise: an extrusion channel configured to accommodate the extrudate; and at least one core vacuum port in fluid communication with the extrusion channel. On the other hand, the housing may comprise: at least one cooling channel; and at least one housing vacuum channel in fluid communication with the extrusion channel. In one preferred embodiment, the cooling channel does not exist in the clad core. However, in other exemplary embodiments, a cooling channel may simply not extend through a clad core. As the cooling channel does not exist in or otherwise extend through the clad core, the cooling channel is adapted to circulate a coolant through the housing. The housing vacuum channel and the core vacuum port may form an improved vacuum pathway adapted to transmit suction forces to the extrudate. As a result of the aforementioned features, a sizer having a clad core may have reduced size, cost, and intricacy; the relationship between a housing and a core may be simplified; the sizer may be more efficient to design and manufacture; and/or the cooling efficiency of the sizer may be improved, which may result in faster extrudate output that is of better quality (e.g., more stable).

The clad core may be comprised of a thermally conductive material. For instance, in one preferred embodiment, the clad core may be comprised of a metal. In other exemplary embodiments, the clad core may be comprised of another thermally conductive material. On the other hand, the housing may be comprised of a thermally conductive material or a non-thermally conductive material. In one preferred embodiment, the housing may be comprised of a polymer. In other exemplary embodiments, the housing may be comprised of another thermally conductive material or non-thermally conductive material.

An example of the clad core may comprise an upper portion and a lower portion, which may be formed separately, though such is not required. The clad core may comprise any number of portions or pieces. The clad core may be formed using additive manufacturing (e.g., metal forming, 3-D printing, etc.) or subtractive manufacturing techniques. Likewise, the core vacuum port(s) may be formed by additive manufacturing or subtractive manufacturing techniques.

The housing may comprise an upper portion and a lower portion, which may be formed separately, though such is not required. The housing may comprise any number of portions or pieces. In an exemplary embodiment, the housing may be created by additive manufacturing techniques, such as but not limited to 3-D printing. In other exemplary embodiments, subtractive manufacturing techniques may be used. The cooling and vacuum channels may comprise one or more non-linear segments, such as but not limited to, smooth curves, though such is not required. The vacuum channel(s) of the housing may be configured to provide fluid communication with the core vacuum port(s) of the clad core when the housing is joined to the clad core. The housing may further comprise one or more cooling inlets and exits for the ingestion and expulsion of cooling fluid. The housing may further comprise one or more vacuum inlets and exits for the ingestion and expulsion of suction forces. In exemplary embodiments, the cooling and vacuum channels may be configured to extend through multiple sizers. In such cases, inlets and exits for cooling fluids and suction forces may not be required on particular sizers.

Additive manufacturing techniques, such as but not limited to 3-D printing, may facilitate the formation of cooling and/or vacuum channels in a housing that may comprise one or more non-linear segments, such as but not limited to, smooth curves, though such is not required.

In addition, or alternatively, the cooling and vacuum channels of a housing may be formed into various geometric cross sections. Such cross sections may be designed to induce or reduce turbulence of cooling fluid flows or to impact particular suction forces, for example, without limitation.

In some exemplary embodiments, the entire housing and clad core may be created as a single piece by additive manufacturing. However, when the clad core and housing are separate pieces, replacement of the clad core may not necessitate replacement of the housing, and vice versa. Moreover, the cooling and vacuum channels of the housing may be provided in one or more standard sizes and shapes.

Compared to a sizer having a core with cooling and vacuum channels, an exemplary embodiment of a sizer having a clad core may allow for less material to be used for the clad core of the sizer, allowing faster and cheaper manufacturing. Additionally, the sizer may permit the creation of improved cooling and vacuum channels in a housing, which may simplify the manufacturing process and result in cost, material, and size efficiencies. Also, improved (e.g., more stable) cooling efficiency may result faster extrudate production that is of better quality (e.g., more consistent products). The cooling and vacuum channels of a housing may be restricted only by the volume of the housing. Vortexes or other shapes creating still or turbulent flows may be provided as needed to cool the profile.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1A is an exploded view of an exemplary embodiment of a sizer;

FIG. 1B is a side view of the sizer of FIG. 1A in an assembled state, wherein certain interior features are illustrated in a hidden state;

FIG. 1C is a cross-sectional view of the sizer of FIG. 1B along section line A-A, wherein an additional upper clad core portion and upper housing portion are also shown for reference;

FIG. 2A is an exploded view of an exemplary embodiment of a sizer;

FIG. 2B is a side view of the sizer of FIG. 2A in an assembled state, wherein certain interior features are illustrated in a hidden state;

FIG. 2C is a cross-sectional view of the sizer of FIG. 2B along section line A-A;

FIG. 3A is an exploded view of an exemplary embodiment of a sizer;

FIG. 3B is a side view of the sizer of FIG. 3A in an assembled state, wherein certain interior features are illustrated in a hidden state;

FIG. 3C is a cross-sectional view of the sizer of FIG. 3B along section line A-A;

FIG. 4A is an exploded view of an exemplary embodiment of a sizer;

FIG. 4B is a side view of the sizer of FIG. 4A in an assembled state, wherein certain interior features are illustrated in a hidden state;

FIG. 4C is a cross-sectional view of the sizer of FIG. 4B along section line A-A;

FIG. 5A is an exploded view of an exemplary embodiment of a sizer;

FIG. 5B is a side view of the sizer of FIG. 5A in an assembled state, wherein certain interior features are illustrated in a hidden state;

FIG. 5C is a cross-sectional view of the sizer of FIG. 5B along section line A-A;

FIG. 6A is an exploded view of an exemplary embodiment of a sizer, wherein a Detail A is identified;

FIG. 6B is Detail A of FIG. 6A;

FIG. 6C is a top plan view of the housing of FIG. 6A;

FIG. 7A is an exploded view of an exemplary embodiment of a sizer;

FIG. 7B is a side view of the sizer of FIG. 7A in an assembled state, wherein certain interior features are illustrated in a hidden state;

FIG. 7C is a cross-sectional view of the sizer of FIG. 7B along section line A-A;

FIG. 8 is an exploded view of an exemplary embodiment of a sizer;

FIG. 9 is an exploded view of an exemplary embodiment of a sizer;

FIG. 10A is an exploded view of an exemplary embodiment of a sizer;

FIG. 10B is an exploded view from a top side of the sizer of FIG. 10A;

FIG. 10C is a cross-sectional view of the sizer of FIG. 10B along section line A-A;

FIG. 11A is an exploded view of an exemplary embodiment of a sizer;

FIG. 11B is a side view of the sizer of FIG. 11A in an assembled state, wherein certain interior features are illustrated in a hidden state;

FIG. 11C is a cross-sectional view of the sizer of FIG. 11B along section line A-A; and

FIG. 11D is a cross-sectional view of the sizer of FIG. 11B along section line B-B.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

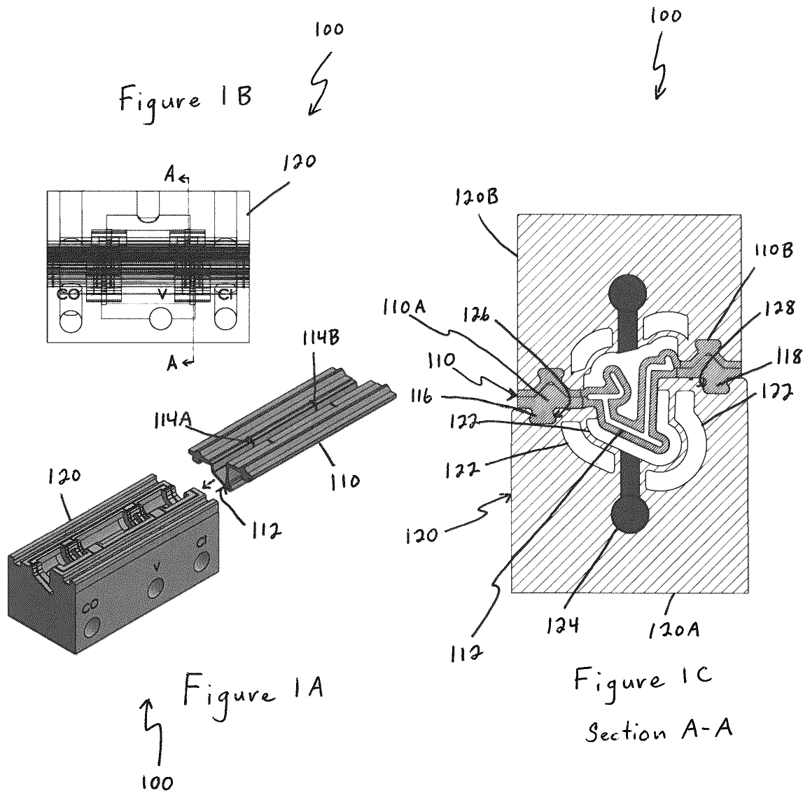

FIGS. 1A-1C illustrate an exemplary sizer 100. The sizer 100 may comprise a clad core 110 and a housing 120. The clad core 110 may comprise an extrusion channel 112 and at least one core vacuum port in fluid communication with the extrusion channel 112. In this example, clad core 110 comprises a core vacuum port 114A and a core vacuum port 1148. The extrusion channel 112 may be configured to accommodate an extrudate.

The profile of the illustrated clad core 110 and extrusion channel 112 is merely exemplary and is not intended to be limiting. Any size, shape, or configuration of the clad core 110 and extrusion channel 112 to create any size, shape, or configuration of an extrudate is contemplated.

On the other hand, housing 120 may comprise at least one cooling channel 122 and at least one housing vacuum channel 124. In this exemplary embodiment, the at least one cooling channel 122 does not exist in the clad core 110. However, in other exemplary embodiments, a cooling channel may simply not extend through a clad core (e.g., the surface of some embodiments of a clad core may not be flat). As the at least one cooling channel 122 does not exist in or otherwise extend through the clad core 110, the at least one cooling channel 122 is adapted to circulate a coolant through the housing 120 for cooling an extrudate. Furthermore, the least one housing vacuum channel 124 is in fluid communication with the extrusion channel 112 via at least one core vacuum port (e.g., core vacuum ports 114A and 114B). As a result, the at least one housing vacuum channel 124 and the at least one core vacuum port may form an improved vacuum pathway adapted to transmit suction forces to an extrudate. In an exemplary embodiment, the improved vacuum pathway may not require an intricate and/or elongated vacuum channel in the clad core.

In this exemplary embodiment, the at least one cooling channel 122 is configured such that a coolant is adapted to contact the clad core 110 when the coolant is circulated through the housing 120, which may improve cooling efficiency. However, as aforementioned, the coolant does not extend through the clad core 110. In other exemplary embodiments, a cooling channel in a housing may be configured such that a coolant is not adapted to contact a clad core when a coolant is circulated through a housing. As another example, there may be a separating layer or structure that is configured to be between a clad core and a coolant. For instance, in one embodiment, a separating layer or structure may be adapted to further optimize the cooling efficiency.

In this exemplary embodiment, the clad core 110 is interlocked with housing 120. In particular, clad core 110 forms a protrusion 116 and a protrusion 118, and housing 120 forms receptacles 126 and 128. Protrusion 116 is interlocked in receptacle 126, and protrusion 118 in interlocked in receptacle 128. Such an embodiment may lessen a need for additional mechanical fasteners, adhesives, and other connection means. However, in other exemplary embodiments, a housing may house a clad core in any other suitable manner.

Such as shown in FIG. 1C, an example of a clad core 110 may comprise a lower portion 110A and an upper portion 1108. A clad core 110 may comprise any number of portions or pieces. For example, without limitation, a clad core 110 may be formed by joining multiple pieces, at least some of which fit into the side of the sizer 100 as inserts. In this example, the lower portion 110A and upper portion 1108 may be configured to fit together. When joined in this example, the lower portion 110A and the upper portion 1108 may further define the extrusion channel 112. However, other exemplary embodiments may have a clad core that does not comprise multiple portions.

In this example, the housing 120 may comprise a lower portion 120A and an upper portion 1208. A housing 120 may comprise any number of portions or pieces. For example, without limitation, a housing 120 may be formed by joining multiple pieces, at least some of which fit into the side of the sizer 100 as inserts. In this example, the lower portion 120A and upper portion 120B may be separately formed, though such is not required. In exemplary embodiments, a housing 120 may be created through additive manufacturing techniques, such as but not limited to 3-D printing. However, in other exemplary embodiments, a housing may be manufactured by any suitable manufacturing techniques, including but not limited to subtractive manufacturing. An example of the housing 120 may be comprised of a polymer, metal, composite, or other material.

As aforementioned, the housing 120 may comprise one or more cooling channels 122. In exemplary embodiments, one or more of the cooling channels 122 may comprise one or more non-linear segments. Such non-linear segments may include, for example without limitation, curves, corkscrews, rounded bends, U-shaped turns, sinuous passageways, S-curves, some combination thereof, or the like. The cooling channel(s) 122 may be configured such that coolant is adapted to be in direct contact with extrusion channel 112 and/or may be configured to extend in proximity to the extrusion channel 112. In exemplary embodiments, the cooling channel(s) 122 may extend along some or all of the extrusion channel 112. In some examples, the cooling channel(s) 122 may be configured to increase or reduce turbulence as required to provide adequate cooling. For example, without limitation, curves, corkscrews, rounded bends, U-shaped turns, sinuous passageways, S-curves, some combination thereof, or the like may be provided to induce turbulence. Alternatively, or additionally, smooth turns and relatively straight passageways may be provided to reduce turbulence and increase flow rate.

In exemplary embodiments, the cooling channel(s) in the housing may closely conform to at least a portion of the shape of the extrusion channel. Also, in an exemplary embodiment, the vacuum channel(s) may closely conform to the shape of the extrusion channel. For example, without limitation, the cooling channel(s) and the vacuum channel(s) may be located between 1/1,000^{th} inch to 2 inches of the extrusion channel 112. Other exemplary embodiments may have other dimensions that allow for desired cooling and vacuum functions.

As previously mentioned, the housing 120 may comprise one or more vacuum channels 124. In exemplary embodiments, the vacuum channel(s) 124 may comprise one or more non-linear segments. Such non-linear segments may comprise, for example without limitation, curves, corkscrews, rounded bends, U-shaped turns, sinuous passageways, S-curves, some combination thereof, or the like. The cooling channel(s) 122 and/or the vacuum channel(s) 124 may be configured to avoid one another. The cooling channel(s) 122 and/or the vacuum channels 124 may not intersect one another. In exemplary embodiments, such cooling channels 122 and vacuum channels 124 may be provided in both the lower portion 120A and upper portion 1208 of the housing, though such is not required.

The cooling channel(s) 122 and/or the vacuum channel(s) 124 may be provided with various geometric cross sections, such as but not limited to, circles, squares, stars, ovals, rectangles, some combination thereof, or the like. The cooling channel(s) 122 and/or the vacuum channel(s) 124 may also be arranged in any suitable configuration in the housing 120. It is contemplated that such various geometric cross sections and configurations may be utilized with any portion of the housing 120.

One or more cooling inlets (labeled CI in FIG. 1A) may be provided in the housing 120 that are in fluid communication with at least one cooling channel 122. One or more cooling outlets (labeled CO in FIG. 1A) may be provided in the housing 120 that are in fluid communication with at least one cooling channel 122. In an exemplary embodiment, it is contemplated that such cooling inlets CI and/or outlets CO may be provided in the lower portion 120A and/or upper portion 120B. One or more vacuum inlets (labeled V in FIG. 1A) may be provided in the housing 120 that are in fluid communication with at least one vacuum channel 124. In an exemplary embodiment, it is contemplated that such vacuum inlet(s) V may be provided in the lower portion 120A and/or the upper portion 1208 of the housing 120. In other exemplary embodiments, the cooling channel(s) and/or the vacuum channel(s) may be configured to interact with the cooling channel(s) and/or the vacuum channel(s) of an adjacent sizer; in such cases, the cooling inlet(s) and outlet(s) and/or the vacuum inlet(s) may not be required. In an exemplary embodiment, the cooling inlets CI and outlets CO and/or the vacuum inlets V may be provided in an outer surface of the housing 120.

The design, shape, and placement of cooling channel(s) 122 and vacuum channel(s) 124 as well as the cooling inlet(s) CI, cooling outlet(s) CO, and vacuum inlet(s) V are each exemplary and are not intended to be limiting. Any design, shape, and placement of such cooling channel(s) 122, vacuum channel(s) 124, cooling inlet(s) CI, cooling outlet(s) CO, and vacuum inlet(s) V are contemplated. In one exemplary embodiment, a cooling channel 122 may have a first end portion adapted to facilitate reception of a coolant, and a second end portion adapted to facilitate exhaustion of the coolant. However, in other exemplary embodiments, reception and exhaustion of a coolant may occur at any suitable portions of a cooling channel. Moreover, in an exemplary embodiment, cooling inlet(s) CI may respectively be fitted with a cooling intake device, and cooling outlet(s) may respectively be fitted a cooling exhaust device.

The at least one cooling channel 122 may be configured to accommodate a coolant, such as but not limited to water. In an exemplary embodiment, the cooling channel(s) 122 may be configured to provide conductive thermal heat transfer between the relatively warm extrudate in the extrusion channel 112 and the coolant in the cooling channel(s) 122. The cooling inlet(s) CI may be placed in fluid communication with a reservoir, pump, tubing, piping, another cooling channel, some combination thereof, or the like which transports coolant to the cooling inlet(s) CI for passage through the cooling channel(s) 122 and to the cooling outlet(s) CO to exit the sizer 100. The cooling outlet(s) CO may be placed in fluid communication with a container, drain, pump, tubing, piping, another cooling channel, some combination thereof, or the like for removing the coolant from the sizer 100.

As aforementioned, the vacuum channel(s) 124 may be in fluid communication with the extrusion channel 112. The vacuum channel(s) 124 may be configured to facilitate the transmission of suction forces to the extrudate located in the extrusion channel 112. The vacuum channel(s) 124 may be configured to provide suction forces, which may provide desirable distribution of extrudate material within the extrusion channel 112 to maintain a shape of an extrudate. The vacuum inlet(s) V may be placed in fluid communication with a pump, tubing, piping, some combination thereof, or the like which transports suction forces to the extrusion channel 126.

The housing 120 may be configured to accommodate a core 110. One example of the core 110 may be comprised of a thermally conductive material such as a metal including, but not limited to, steel, aluminum, stainless steel, another thermally conductive material, or some combination thereof. In other exemplary embodiments, the core 110 may be comprised of a non-metallic, thermally conductive material such as a polymer, composite, or the like. In some exemplary embodiments, such as those shown in the figures herein, the core 110 may be created using additive manufacturing (e.g., metal forming), subtractive manufacturing, some combination thereof, or the like. The at least one core vacuum port (e.g., 114A and 114B) in the core 110 may likewise be formed using additive manufacturing (e.g., metal forming), subtractive manufacturing (e.g., drilling, wire EDM, some combination thereof, or the like), some combination thereof, or the like. For instance, metal forming may be used to form the clad core, and subsequently wire EDM may be used to create at least one core vacuum port.

In an exemplary embodiment, the lower portion 120A and the upper portion 120B of the housing 102 may be configured to fit together. In other exemplary embodiments, a lower portion and an upper portion of a housing may be secured together in any suitable manner. Likewise, in an example of a clad core having a lower portion and an upper portion, such portions may be secured together in any suitable manner.

One or more alignment devices may be provided in the housing. In exemplary embodiments, one or more alignment channels may be provided in the upper portion 1208 of the housing 120 and one or more corresponding alignment protrusions may be provided in the lower portion 120A of the housing 120, though the reverse is contemplated. The alignment protrusions may be configured to be mated with the alignment channels. In other embodiments, alignment devices may comprise channels, and a rod, clamp, fastener or other device may be inserted through the alignment channels.

As addressed above, the clad core and/or the housing may be comprised of any number of portions or pieces that are joined together. As another example, at least one of an upper clad core portion and a lower clad core portion may be respectively formed of multiple pieces that are joined together. For instance, an upper clad core portion may be comprised of multiple pieces that are joined together while the lower clad core portion is comprised of a single piece, or vice versa. Likewise, an exemplary embodiment may comprise at least one of an upper housing portion and a lower housing portion that is respectively formed of multiple pieces that are joined together. Again, as with the examples of a clad core, an upper housing portion may be comprised of multiple pieces that are joined together while the lower housing portion is comprised of a single piece, or vice versa.

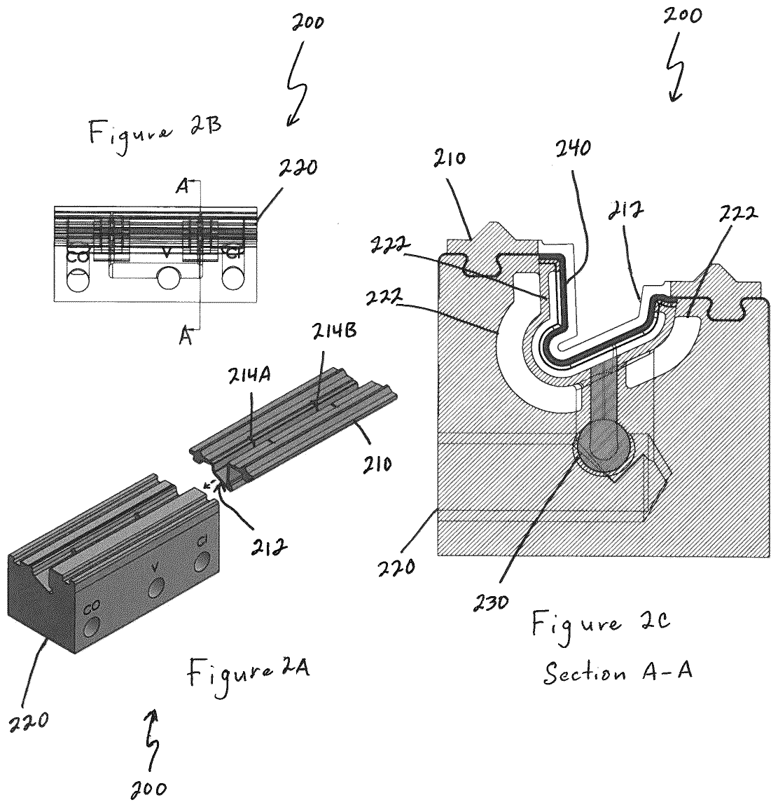

Other variations of a housing and a core are possible. For example, FIGS. 2A-11D show various embodiments of sizers respectively comprising at least one housing portion and at least one clad core portion. In these examples, only a lower housing portion and lower clad core portion are shown for ease of reference, wherein the lower housing portion and the lower core portion are configured to be associated with an upper housing portion and an upper clad core portion such as previously discussed. Other exemplary embodiments may comprise one housing portion and one clad core portion. For yet another example, such as noted above, the entire housing and clad core may be created as a single piece. For instance, a clad core and a housing may be created by being printed together by additive manufacturing (e.g., 3-D printing). However, unless otherwise specified, any suitable manufacturing techniques may be used to create any number of pieces of a housing and a clad core. Furthermore, the examples shown in FIGS. 2A-11D may benefit from any of the features of the other embodiments of this application.

FIGS. 2A-2C illustrate one exemplary embodiment in which a cooling channel is in close proximity to a clad core. This exemplary embodiment may otherwise be similar to the previous example. In this example, sizer 200 is comprised of a clad core 210 that is housed by a housing 220. Clad core 210 comprises an extrusion channel 212 that is adapted to accommodate an extrudate. Housing 220 has at least one input (labeled CI) and at least one output (labeled CO) for the coolant, and at least one inlet (labeled V) adapted to receive the suction force of a vacuum (i.e., adapted to be in fluid communication with a vacuum source). The at least one inlet for a vacuum is associated with a vacuum channel 230 that extends through housing 220 to core vacuum ports 214A and 214B of clad core 210. On the other hand, for cooling, this exemplary embodiment has at least one cooling channel 222, which extends through housing 220.

In this exemplary embodiment, a separation layer 240 is provided that separates at least a portion of the clad core 210 from at least a portion of the housing 220. In another exemplary embodiment, a separation layer may separate a portion of a clad core from a cooling channel such that a coolant is not adapted to contact the clad core when the coolant is circulated through a housing. In this exemplary embodiment, the separation layer 240 is positioned entirely between cooling channel 222 and clad core 210. However, in other exemplary embodiments, a separation layer may leave a desired portion of a clad core unseparated from or otherwise exposed to a cooling channel or other portion of a housing. In this example, separation layer 240 is secured to housing 220. In other exemplary embodiments, a separation layer may be secured to a clad core or may be unsecured to both a clad core and a housing. A separation layer may also be removable or permanent. An example of a separation layer may be comprised of a polymer or any other suitable material that provides desired separation. In one exemplary embodiment, a separation layer may be comprised of a polymer or other material that is adapted to improve the heat transfer between a clad core and a coolant or housing surface. Furthermore, the other exemplary embodiments described herein may be adapted to include a separation layer.

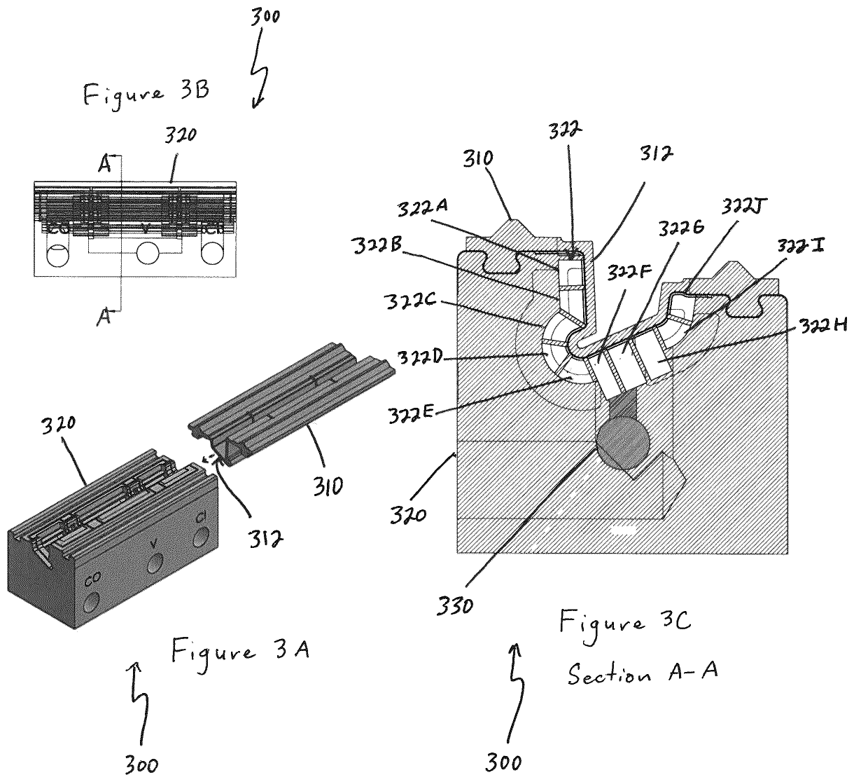

Exemplary embodiments may also control the cooling of an extrudate by the position or other characteristics of the at least one cooling channel. FIGS. 3A-3C show one example of a sizer 300 having at least one cooling channel that is adapted to facilitate control of the cooling of an extrudate and/or to adapt to space limitations within a housing. Sizer 300 is comprised of a clad core 310 that is positioned in a housing 320. Clad core 310 comprises an extrusion channel 312 that is adapted to accommodate an extrudate. Housing 320 has at least one input (labeled CI) and at least one output (labeled CO) for the coolant, and at least one inlet (labeled V) adapted to receive the suction force of a vacuum (i.e., adapted to be in fluid communication with a vacuum source). The at least one inlet for a vacuum is associated with a vacuum channel 330 that extends through the housing 320. On the other hand, for cooling, this exemplary embodiment has at least one cooling channel 322, which extends through housing 320.

In this example, at least one cooling channel 322 has a portion 322A, portion 322B, portion 322C, portion 322D, portion 322E, portion 322F, portion 322G, portion 322H, portion 322I, and portion 322J adjacent to the extrusion channel 312. In order to facilitate control of the cooling of an extrudate, portion 322F, portion 322G, and portion 322H are larger (i.e., more volume as determined when there is a cross-section across the width of the extrusion channel 312) than the remaining portions to facilitate the receipt of more coolant in those areas for better cooling of an extrudate in those areas (compared to the remaining portions, which are adapted to receive less coolant, respectively, for less cooling impact in those areas). Such an example may be useful for cooling an extrudate that has different thicknesses or materials in certain areas (e.g., next to portion 322F, portion 322G, and portion 322H in this example) that require different cooling. As another example, space may be limited for some portions of a cooling channel, which may require a relatively small cooling portion in that area (e.g., around cooling portion 322J in this example). Other exemplary embodiments may have a different number, size characteristics, and/or placement of the portions of a cooling channel adjacent to an extrusion channel to facilitate desired control of the cooling of an extrudate.

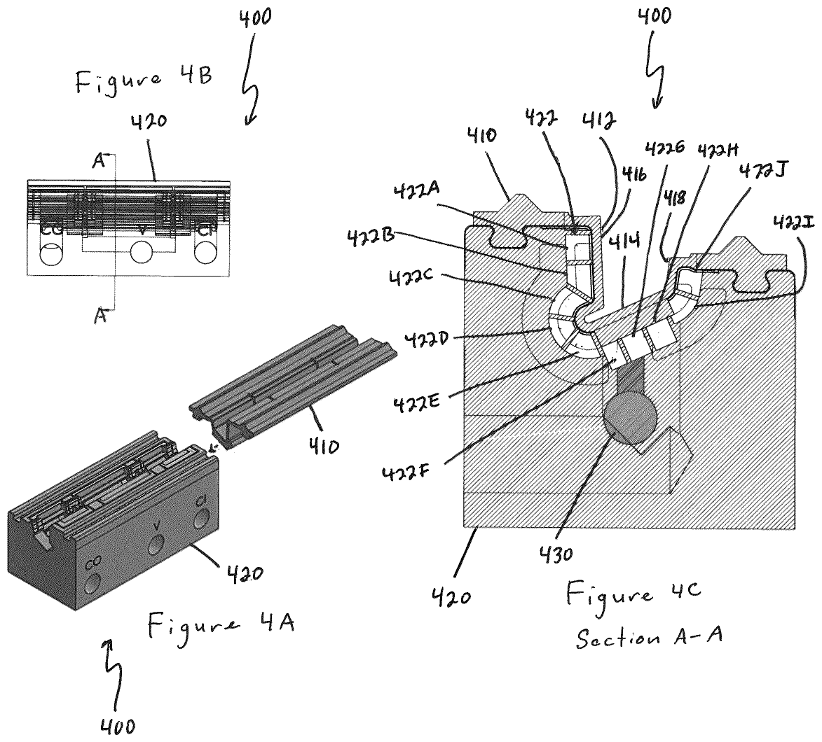

Exemplary embodiments may also control the cooling of an extrudate by the thickness of a clad core between a cooling channel and an extrusion channel. FIGS. 4A-4C show one example of a sizer 400 having different thicknesses of a clad core between a cooling channel and an extrusion channel to facilitate control of the cooling of an extrudate. Sizer 400 is comprised of a clad core 410 that is positioned in a housing 420. Clad core 410 comprises an extrusion channel 412 that is adapted to accommodate an extrudate. Housing 420 has at least one input (labeled CI) and at least one output (labeled CO) for the coolant, and at least one inlet (labeled V) adapted to receive the suction force of a vacuum (i.e., adapted to be in fluid communication with a vacuum source). The at least one inlet for a vacuum is associated with a vacuum channel 430 that extends through the housing 420 to the core vacuum ports. On the other hand, for cooling, this exemplary embodiment has at least one cooling channel 422, which extends through housing 420 and about extrusion channel 412.

In this example, at least one cooling channel 422 has a portion 422A, portion 422B, portion 422C, portion 422D, portion 422E, portion 422F, portion 422G, portion 422H, portion 422I, and portion 422J adjacent to the extrusion channel 412. In order to facilitate control of the cooling of an extrudate, a portion 414 of the clad core 410 is thicker between the extrusion channel 412 and cooling channel 422 to lessen the cooling effect in that area (compared to portions 416 and 418, which are thinner, respectively, for less cooling impact). In other exemplary embodiments, a thicker portion may be situated elsewhere with respect to at least one portion of a cooling channel. Such an example may be useful for cooling an extrudate more slowly where the clad core is thickest between an extrusion channel and a cooling channel. This exemplary embodiment may be beneficial for an extrudate that has different thicknesses or materials in certain areas that require different cooling. Other exemplary embodiments may have a different number, size characteristics (e.g., wavy thickness changes, multiple thickness changes, etc.), and/or placement of at least one portion of a clad core that is thicker (compared to other portions) between at least one cooling channel and an extrusion channel to facilitate desired control of the cooling of an extrudate.

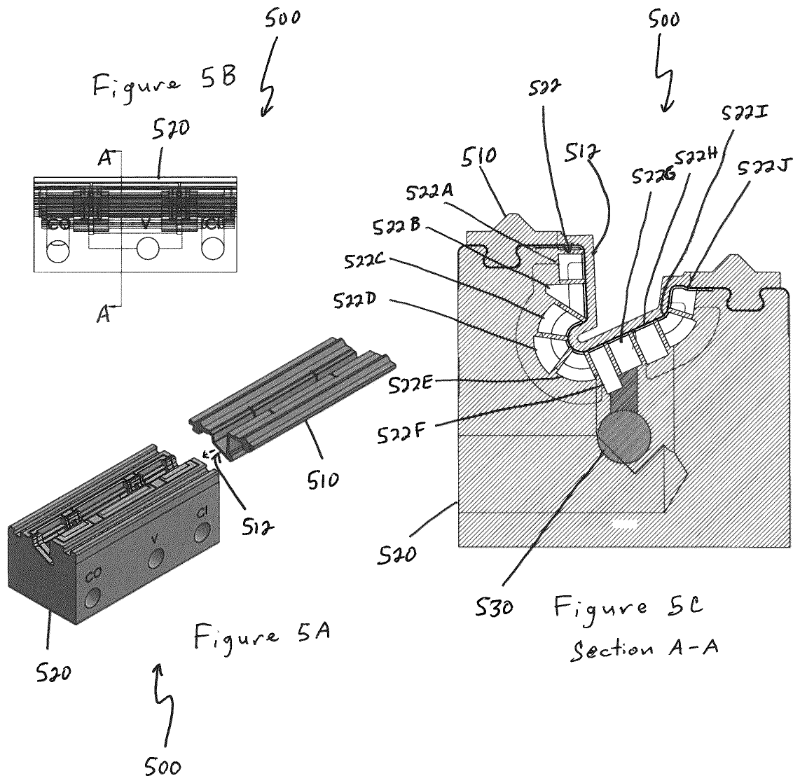

It may also be desirable to control the flow rate of a coolant through the portions of a cooling channel. For instance, the cooling of an extrudate may be unbalanced if the flow rate of a coolant is uneven through the portions of a cooling channel. In view of this need, exemplary embodiments may also facilitate control of the cooling of an extrudate by promoting more balanced cooling velocity in the portions of a cooling channel. FIGS. 5A-5C show one example of a sizer 500 adapted to facilitate control of the coolant velocity. Sizer 500 is comprised of a clad core 510 that is positioned in a housing 520. Clad core 510 comprises an extrusion channel 512 that is adapted to accommodate an extrudate. Housing 520 has at least one input (labeled CI) and at least one output (labeled CO) for the coolant, and at least one inlet (labeled V) adapted to receive the suction force of a vacuum (i.e., adapted to be in fluid communication with a vacuum source). The at least one inlet for a vacuum is associated with a vacuum channel 530 that extends through the housing 520 to the core vacuum ports. On the other hand, for cooling, this exemplary embodiment has at least one cooling channel 522, which extends through housing 520 and about extrusion channel 512.

In this example, at least one cooling channel 522 has a portion 522A, portion 522B, portion 522C, portion 522D, portion 522E, portion 522F, portion 522G, portion 522H, portion 522I, and portion 522J adjacent to the extrusion channel 512. In order to achieve more uniform cooling of an extrudate in this exemplary embodiment, the cooling portions have respective sizes adapted to facilitate control of cooling by promoting more balanced cooling velocity in each of the portions as compared to an otherwise similar clad core cooling channel in which none of the portions differ in size. For instance, in this example, portion 522B is larger than portion 522A, in order to facilitate more balanced cooling velocity in each of the portions. On the other hand, portion 522I is larger than portion 522J in this embodiment to facilitate more balanced cooling velocity in those portions. Such an example may be useful such as when the shapes of a clad core and/or a housing require or result in a cooling channel that would otherwise promote unbalanced cooling velocities in the respective portions of the cooling channel. In other words, the respective shapes of the portions of a cooling channel adjacent to an extrusion channel may influence the cooling velocity in each channel. More balanced cooling velocity may be particularly useful such as when an extrudate has a similar thickness throughout to facilitate more uniform cooling. Other exemplary embodiments may have a different number, size characteristics, and/or placement of the portions of a cooling channel adjacent to an extrusion channel to facilitate more balanced cooling velocity control.

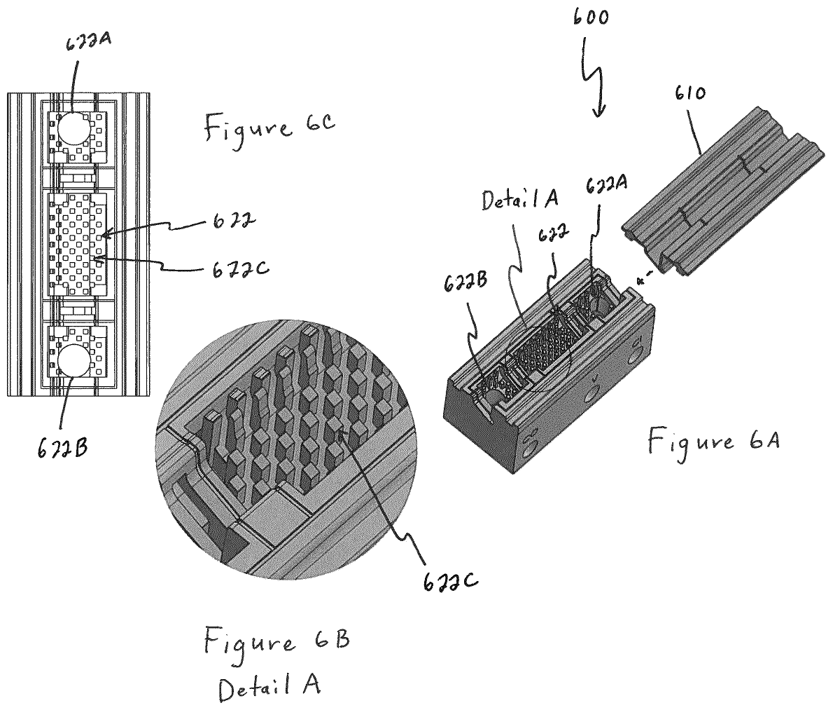

It may also be desirable to be able to facilitate control of the cooling of an extrudate in other manners. FIGS. 6A-6C show an example of a sizer that is adapted to facilitate heat transfer. In this exemplary embodiment, sizer 600 is comprised of a clad core 610 that is positioned in a housing 620. In this exemplary embodiment, the housing comprises a cooling channel 622 that is adapted to induce a turbulent flow of a coolant through the cooling channel 622 in order to facilitate control of cooling of an extrudate. In this embodiment, a coolant is adapted to enter coolant inlet CI, flow through an opening 622A and across to opening 622B, and then out cooling outlet CO. In this example, cooling channel 622 is adapted to induce a turbulent flow when a coolant flows from opening 622A to opening 622B. In particular, the cooling channel may comprise at least one (e.g., preferably a plurality) of protrusions 622C that extend into the cooling channel to induce a turbulent flow of a coolant. The protrusion(s) 622C are adapted to break up, agitate, or otherwise disrupt the flow of a coolant from opening 622A to opening 622B. In an exemplary embodiment, a turbulent coolant flow in the cooling channel 622 may improve heat transfer. In other exemplary embodiments, a cooling channel may have a different number, shape, or placement of at least one protrusion in a cooling channel to facilitate desired cooling control.

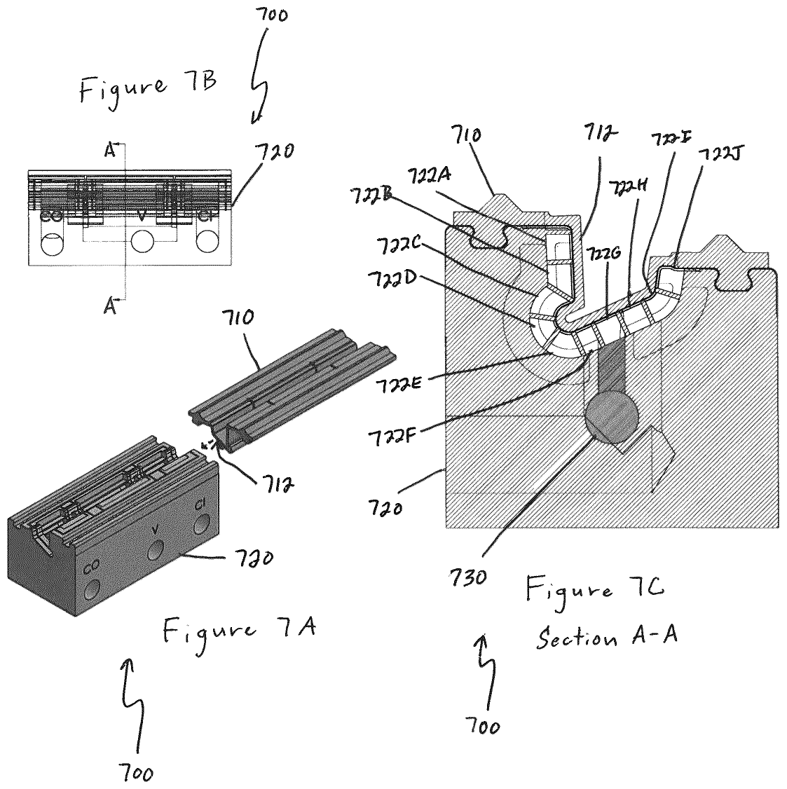

Any of the exemplary embodiments may include at least one cooling channel that is continuous or non-continuous adjacent to at least a portion of the width of an extrusion channel (as determined when there is a theoretical cross-section along the width of the extrusion channel). Certain embodiments may benefit from being continuous or non-continuous adjacent to the width of an extrusion channel. FIGS. 7A-7C show one example of a sizer 700 having cooling channels that are adapted to facilitate control of the cooling of an extrudate and/or to adapt to space limitations within a housing. Sizer 700 is comprised of a clad core 710 that is positioned in a housing 720. Clad core 710 comprises an extrusion channel 712 that is adapted to accommodate an extrudate. Housing 720 may have at least one input and at least one output for the coolant, and at least one inlet adapted to receive the suction force of a vacuum (i.e., adapted to be in fluid communication with a vacuum source). The at least one inlet for a vacuum is associated with a vacuum channel 730 that extends through the housing 720 to the core vacuum ports. On the other hand, for cooling, this exemplary embodiment has at least one cooling channel 722, which extends through housing 720.

In this example, at least one cooling channel 722 has a portion 722A, portion 722B, portion 722C, portion 722D, portion 722E, portion 722F, portion 722G, portion 722H, portion 722I, and portion 722J adjacent to the extrusion channel 712. In this exemplary embodiment, the portions respectively form individual cooling portions that are positioned adjacent to the extrusion channel. Regarding individual cooling portions, this determination is made when there is a theoretical cross-section along a width of the extrusion channel, such as shown in FIG. 7C. “Individual cooling portions” is not intended to preclude the portions from being joined at their proximal ends, again such as shown in the example of FIG. 7C. In this exemplary combination, the cooling portions are positioned substantially about an entirety of the width of the extrusion channel. Other exemplary embodiments may have a cooling channel that is continuous adjacent to at least a major portion of a width of extrusion channel, such as shown in the example of FIG. 1C. In this instance, a major portion is defined to be at least half of the width of the extrusion channel, and is determined when there is a theoretical cross-section along the width of the extrusion channel. Other exemplary embodiments may have a different number, size characteristics, and/or placement of the at least one portion of the at least one cooling channel adjacent to an extrusion channel to facilitate desired control of the cooling of an extrudate.

In any of the aforementioned embodiments, a cooling channel may be adapted to circulate any suitable coolant for an application. Examples of suitable coolants may comprise liquids and gases, or other suitable materials, which may be natural or synthetic.

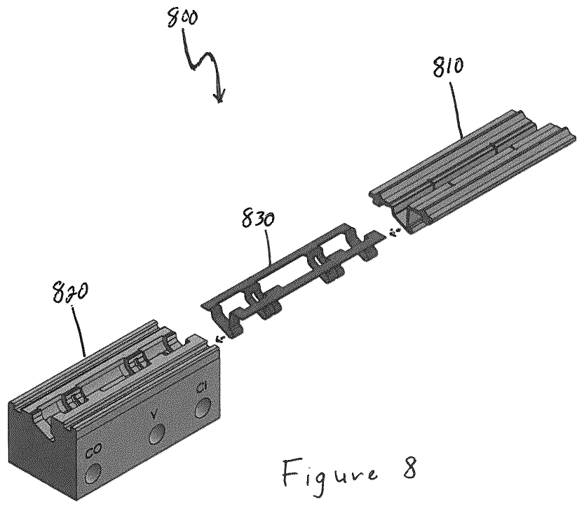

Exemplary embodiments may also include a seal that is adapted to limit leakage of the coolant between a clad core and a housing. FIG. 8 shows one example of the use of a conformal seal. In this exemplary embodiment, sizer 800 comprises a clad core 810 that is positioned in a housing 820. Clad core 810 and housing 820 may be similar to, or different than, other clad cores and housings discussed herein. However, in this exemplary embodiment, sizer 800 further comprises a conformal seal 830 positioned between clad core 810 and housing 820, which is adapted to limit leakage of the coolant between the clad core 810 and housing 820.

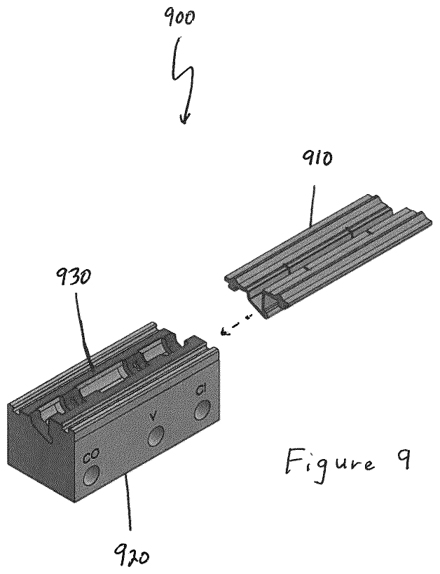

Other exemplary embodiments may have a seal that is not conformal. For instance, examples of a seal may be selected from a group consisting of O-rings, printed seals, continuous cut seals, and overmolded seals, or other suitable types of seals, which may or may not be conformal. An example of a seal may be comprised of a rigid or flexible material, such as but not limited to plastics. As a further example, a seal may be integrated in a housing, such as but not limited to an overmolded seal. FIG. 9 shows an example of an overmolded seal. In this exemplary embodiment, sizer 900 comprises a clad core 910 and a housing 920, which may be similar to, or different than, other clad cores and housings discussed herein. In this example, conformal seal 930 is overmolded with housing 920 in an additive manufacturing process (e.g., 3-D printing). In other exemplary embodiments, a seal may be overmolded with a clad core.

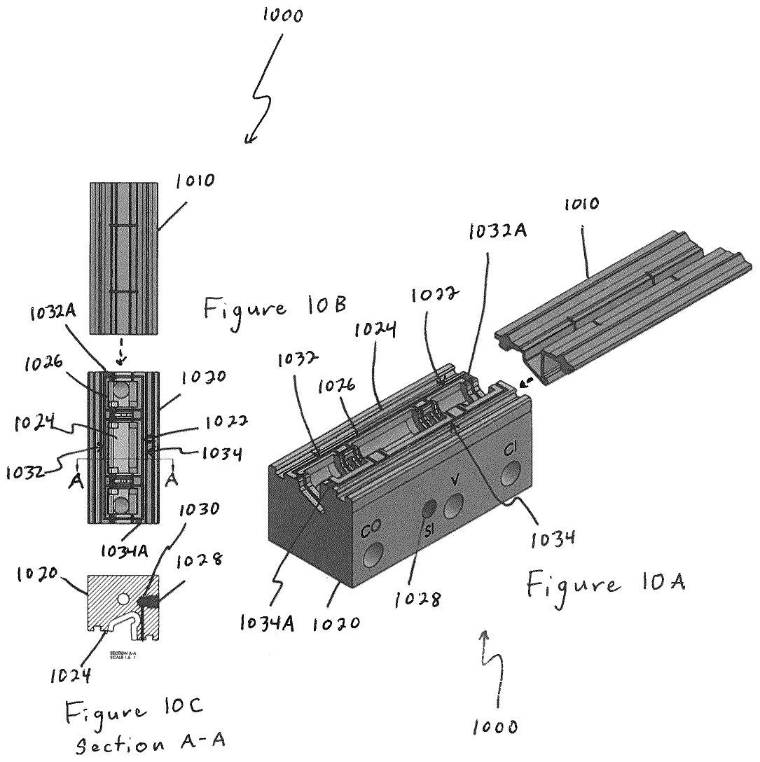

Other variations of a seal and an associated method of manufacture are possible. FIGS. 10A-10C show one example of the use of a seal that may be injected into a housing and/or a clad core. In this exemplary embodiment, sizer 1000 comprises a clad core 1010 that is positioned in a housing 1020. Clad core 1010 and housing 1020 may be similar to, or different than, other clad cores and housings discussed herein. In this exemplary embodiment, the housing 1020 comprises at least one groove 1022 on a surface 1024 that is adjacent to the clad core 1010. A seal 1026 is positioned in the at least one groove 1022 such that the seal 1026 is positioned between clad core 1010 and housing 1020. As a result, seal 1026 is adapted to limit leakage of a coolant between the clad core 1010 and housing 1020.

A seal 1026 may be manufactured prior to, simultaneously with (e.g., 3-D printing), or otherwise separately from (e.g., after) least one groove 1022. In this exemplary embodiment, seal 1026 is formed by injection into at least one groove 1022. In particular, housing 1020 comprises at least one seal injection port 1028 that is adapted to facilitate injection of a sealant material into the at least one groove 1022 to form the seal 1026. In this embodiment, the sealant material may be comprised of a rigid or flexible material that is injectable, such as but not limited to plastics. In this example, seal injection port 1028 is in fluid communication with a sealant channel 1030 that is configured to inject the sealant material into at least one groove 1022. More particularly, at least one groove 1022 is comprised of a seal runner 1032 and a seal runner 1034, which are interconnected in this example. However, in other exemplary embodiments, seal runners may not be interconnected. In order to ensure that the sealant material flows throughout at least one groove 1022, seal runner 1032 may comprise at least one sealant vent 1032A, and seal runner 1034 may comprise at least one sealant vent 1034A.

In another exemplary embodiment, a clad core may comprise at least one groove on a surface that is adjacent to a housing. A seal may be positioned in the at least one groove such that the seal is positioned between the clad core and the housing. This example may otherwise be similar to the example in FIGS. 10A-10C to limit leakage of a coolant between a clad core and a housing.

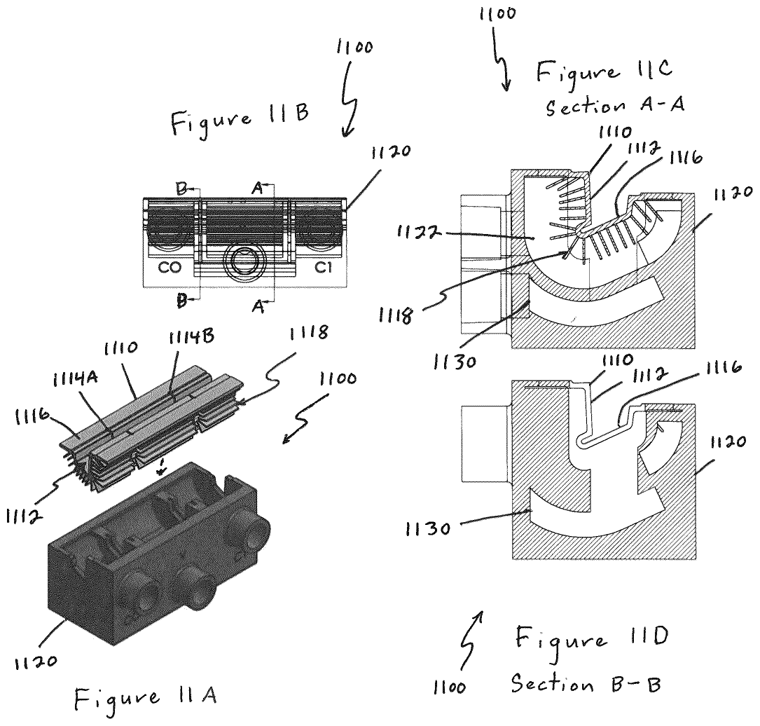

Exemplary embodiments may also include other features adapted to improve heat transfer between an extrudate and a coolant. FIGS. 11A-11C show one example of a sizer 1100 having improved heat transfer features to facilitate control of the cooling of an extrudate. Sizer 1100 is comprised of a clad core 1110 that is positioned in a housing 1120. Clad core 1110 comprises an extrusion channel 1112 that is adapted to accommodate an extrudate. Housing 1120 has at least one input (labeled CI) and at least one output (labeled CO) for the coolant, and at least one inlet (labeled V) adapted to receive the suction force of a vacuum (i.e., adapted to be in fluid communication with a vacuum source). The at least one inlet for a vacuum is associated with a vacuum channel 1130 that extends through the housing 1120 to the core vacuum port 1114A and core vacuum port 11148. On the other hand, for cooling, this exemplary embodiment has at least one cooling channel 1122, which extends through housing 1120 and about extrusion channel 1112.

In this exemplary embodiment, clad core 1110 is configured to be in contact with a coolant that flows through at least one cooling channel 1122. In other words, the cooling channel 1122 is configured such that the coolant is adapted to contact the clad core 1110 when the coolant is circulated through the housing 1120. More particularly, in this exemplary embodiment, the clad core 1110 comprises a main body 1116 and at least one protrusion 1118 that extends from the main body 1116 into the cooling channel 1122 such that the at least one protrusion 1118 is adapted to contact the coolant when the coolant is circulated through the housing 1120. In this exemplary embodiment, multiple protrusions 1118 extend from main body 1116 into the cooling channel 1122, wherein each of the protrusions 1118 is a fin. In other exemplary embodiments, a clad core may have multiple protrusions that are different shapes. Likewise, other exemplary embodiments of at least one protrusion may have a different shape, placement, configuration, and/or arrangement such that the least one protrusion is adapted to contact a coolant.

An example of a clad core 1110 may be manufactured using additive manufacturing, subtractive manufacturing, combinations thereof, or the like. Furthermore, an example of clad core 1110 may be comprised of a thermally conductive material such as but not limited to a metal. Other exemplary embodiments may be comprised of another thermally conductive material such as polymers, composites, combinations of any of the aforementioned materials, or the like.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A sizer for cooling an extrudate, comprising:
a clad core, comprising:
an extrusion channel configured to accommodate the extrudate; and
a core vacuum port in fluid communication with the extrusion channel;
wherein the clad core is comprised of a metal; and
a housing for housing the clad core, comprising:
a cooling channel; and
a housing vacuum channel in fluid communication with the extrusion channel;
wherein the housing is comprised of a polymer;
wherein the cooling channel does not exist in the clad core and is adapted to circulate a coolant through the housing; and
wherein the housing vacuum channel and the core vacuum port form a vacuum pathway adapted to transmit suction forces to the extrudate.

2. The sizer of claim 1 wherein:
the cooling channel has a first end portion adapted to facilitate reception of the coolant and a second end portion adapted to facilitate exhaustion of the coolant; and
the housing vacuum channel has a first end portion adapted to facilitate intake of the suction forces.

3. The sizer of claim 2 further comprising:
a cooling intake located at the first end portion of the cooling channel and adapted to receive the coolant;
a cooling exhaust located at the second end portion of the cooling channel and adapted to exhaust the coolant; and
a vacuum intake located at the first end portion of the housing vacuum channel and adapted to intake the suction forces.

4. The sizer of claim 1 wherein:
the cooling channel is configured to closely conform to the extrusion channel along at least a portion thereof.

5. The sizer of claim 4 wherein:
the cooling channel extends between 1/100^{th} and 2 inches from the extrusion channel.

6. The sizer of claim 1 wherein:
the cooling channel is adapted to induce a turbulent flow of the coolant through the cooling channel in order to facilitate control of cooling of the extrudate.

7. The sizer of claim 6 wherein:
the cooling channel comprises a plurality of protrusions extending into the cooling channel to induce the turbulent flow of the coolant.

8. The sizer of claim 1 wherein:
the cooling channel has portions adjacent to the extrusion channel that differ in size and are adapted to facilitate control of cooling of the extrudate or to adapt to space limitations.

9. The sizer of claim 1 wherein:
the cooling channel has portions of respective sizes adjacent to the extrusion channel and adapted to facilitate control of cooling by promoting more balanced cooling velocity in each of the portions as compared to an otherwise similar cooling channel in which none of the portions differ in size.

10. The sizer of claim 1 wherein:
the cooling channel is continuous adjacent to at least a major portion of a width of the extrusion channel, wherein the major portion is determined when there is a theoretical cross-section along the width of the extrusion channel.

11. The sizer of claim 1 wherein:
the cooling channel alone, or in coordination with at least one additional cooling channel, forms individual cooling portions that are positioned adjacent to the extrusion channel, wherein the individual cooling portions are determined when there is a theoretical cross-section along a width of the extrusion channel.

12. The sizer of claim 11 wherein:
the individual cooling portions are positioned adjacent to substantially an entirety of the width of the extrusion channel.

13. The sizer of claim 1 wherein:
the clad core has portions adjacent to the extrusion channel that differ in thickness and are adapted to facilitate control of cooling of the extrudate.

14. The sizer of claim 1 wherein:
the clad core comprises an upper clad core portion and a lower clad core portion; and
the upper clad portion and the lower clad portion are separately formed.

15. The sizer of claim 14 wherein:
at least one of the upper clad portion and the lower clad portion is respectively formed of multiple pieces that are joined together.

16. The sizer of claim 1 wherein:
the housing comprises an upper housing portion and a lower housing portion; and
the upper housing portion and the lower housing portion are separately formed.

17. The sizer of claim 16 wherein:
at least one of the upper housing portion and the lower housing portion is respectively formed of multiple pieces that are joined together.

18. The sizer of claim 1 wherein:
the housing vacuum channel comprises at least one curved segment.

19. The sizer of claim 1 wherein:
the cooling channel comprises at least one curved segment.

20. The sizer of claim 1 wherein:
the cooling channel comprises a non-circular cross section; or
the housing vacuum channel comprises a non-circular cross section.

21. The sizer of claim 1 wherein:
the metal is a thermally conductive material; and
the polymer is a thermally conductive material or a non-thermally conductive material.

22. The sizer of claim 1 wherein:
the metal is stainless steel.

23. The sizer of claim 1 wherein:
the clad core has been created by additive manufacturing; or
the housing has been created by additive manufacturing.

24. The sizer of claim 23 wherein:
the clad core and the housing have been created by being printed together.

25. The method of claim 23 wherein:
a portion of the housing is subsequently created by subtractive manufacturing after additive manufacturing.

26. The method of claim 23 wherein:
a portion of the clad core is subsequently created by subtractive manufacturing after additive manufacturing.

27. The sizer of claim 1 further comprising:
a seal positioned between the housing and the clad core;
wherein the seal is adapted to limit leakage of the coolant between the housing and the clad core.

28. The sizer of claim 27 wherein:
the seal is comprised of a rigid or flexible material.

29. The sizer of claim 27 wherein:
the seal is integrated in the housing.

30. The sizer of claim 27 wherein:
the seal is selected from the group consisting of O-rings, printed seals, continuous cut seals, and overmolded seals.

31. The sizer of claim 27 wherein:
the seal is a conformal seal.

32. The sizer of claim 27 wherein:
the housing comprises:
(i) a groove on a surface adjacent to the clad core; and
(ii) a sealant injection port that is adapted to facilitate injection of a sealant material into the groove to form the seal.

33. The sizer of claim 27 wherein:
the clad core comprises:
(i) a groove on a surface adjacent to the housing; and
(ii) a sealant injection port that is adapted to facilitate injection of a sealant material into the groove to form the seal.

34. The sizer of claim 1 wherein:
the cooling channel is adapted to circulate a coolant selected from the group consisting of liquids and gases.

35. The sizer of claim 1 wherein:
the cooling channel is configured such that the coolant is adapted to contact the clad core when the coolant is circulated through the housing.

36. The sizer of claim 35 wherein:
the clad core comprises a main body and at least one protrusion that extends from the main body into the cooling channel such that the at least one protrusion is adapted to contact the coolant when the coolant is circulated through the housing.

37. The sizer of claim 36 wherein:
the at least one protrusion is a fin.

38. The sizer of claim 1 wherein:
the clad core is interlocked with the housing.

39. The sizer of claim 1 further comprising:
a separation layer that separates a portion of the clad core from the housing;
wherein the separation layer is comprised of a polymer.

40. The sizer of claim 39 wherein:
the separation layer separates the portion of the clad core from the cooling channel such that a coolant is not adapted to contact the clad core when the coolant is circulated through the housing.
